(19) United States
(12) Patent Application Publication
(10) Pub. No.: US 2014/0085577 A1
(43) Pub. Date: Mar. 27, 2014

(54) ARRAY SUBSTRATE AND DISPLAY DEVICE COMPRISING THE SAME

(71) Applicant: Weifeng Zhou, Beijing (CN)

(72) Inventor: Weifeng Zhou, Beijing (CN)

(73) Assignee: BOE TECHNOLOGY GROUP CO., LTD., Beijing (CN)

(21) Appl. No.: 13/823,329

(22) PCT Filed: Nov. 6, 2012
(86) PCT No.: PCT/CN2012/084160

§ 371 Date: Mar. 14, 2013

(30) Foreign Application Priority Data
Mar. 23, 2012 (CN) 201210080930.3

(51) Int. Cl. G02F 1/1362

(52) U.S. Cl. CPC G02F 1/136209; G02F 1/136286
USPC 349/106

(57) ABSTRACT

The embodiments of the present invention disclose an array substrate and a display device comprising the array substrate. The array substrate comprises a pixel electrode and a common electrode, and a color resin layer between the pixel electrode and the common electrode, and conductive particles are dispersed within the color resin layer.

### TECHNICAL FIELD

Embodiments of the present invention relate to an array substrate and a display device comprising the array substrate.

### BACKGROUND

Color Filter on Array (COA) is a technology for manufacturing color filters directly on an array substrate of a liquid crystal display panel. FIG. 1 shows an array substrate adopting the COA technology in the prior art.

As shown in FIG. 1, a plurality of thin film transistors T are arranged in an array on a substrate S, and a color resin layer, which comprises a red resin R, a green resin G and a blue resin B, is formed between the thin film transistors T and pixel electrodes ITO. In manufacturing the liquid crystal display panels using the COA technology, the step of precisely aligning the color filter substrate with the array substrate can be omitted, thus the production efficiency is significantly improved. At the same time, the integrated level of the liquid crystal display panel can be improved and therefore the power consumption of the liquid crystal display panel is lowered.

Fringe Field Switching (FFS) is a technology for wide viewing angle, which is developed for the application of desktop computers and liquid crystal televisions with a large size and high definition. The liquid crystal display panel manufactured by the FFS technology has such advantages as wide viewing angle, high aperture ratio and etc. FIG. 2 shows an FFS type liquid crystal display panel in the prior art.

As shown in FIG. 2, the FFS type liquid crystal display panel comprises an array substrate 21, a color filter substrate 22 and liquid crystal molecules 23 between the two substrates. A color resin layer 24 is formed on the color filter substrate 22 at the side surface thereof facing the array substrate 21. A common electrode 26 is formed on the array substrate 21 and below pixel electrodes 25, an insulating layer 27 being formed between the common electrode 26 and the pixel electrodes 25. When a voltage is applied between the pixel electrodes 25 and the common electrode 26, edge electric fields are generated between pixel electrodes within the same plane, whereby the liquid crystal molecules between the pixel electrodes and right over the pixel electrodes as well can be deflected in a direction of the plane, thus improving the aperture ratio of the liquid crystal display panel.

In order to further improve the integrated level and the production efficiency of the FFS type liquid crystal display panel, it is proposed to apply the COA technology to the FFS type liquid crystal display panel, i.e., forming the color resin layer on a surface of the array substrate manufactured with thin film transistors thereon so as to cover the thin film transistors, then forming pixel electrode via holes in the color resin layer, and finally forming pixel electrodes on the color resin layer.

On the aforesaid array substrate applied with the COA technology, the color resin layer is located between the pixel electrodes and the common electrode. Since the color resin layer has a relatively greater thickness, usually 1 μm-2 μm, and the pixel structure of the FFS type liquid crystal display panel requires an electric field to be established between the pixel electrode and the common electrode, depending on which electric field the liquid crystal molecules are deflected, the thicker color resin layer will greatly reduce the strength of the electric field and the liquid crystal molecules can not be deflected normally, thus reducing the aperture ratio of the FFS type liquid crystal display panel, whereby the COA technology can not be applied directly to the FFS type liquid crystal display panel.

### SUMMARY

One embodiment of the present invention provides an array substrate, which comprises a pixel electrode and a common electrode, and a color resin layer between the pixel electrode and the common electrode, wherein conductive particles are dispersed within the color resin layer.

Another embodiment of the present invention provides a display device, which comprises the aforesaid array substrate.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a sectional schematic view of an array substrate adopting the COA technology in the prior art;

FIG. 2 is a sectional schematic view of an FFS type liquid crystal display panel in the prior art; and

FIG. 3 is a sectional schematic view of an array substrate in an FFS type liquid crystal display panel adopting the COA technology in an embodiment of the present invention.

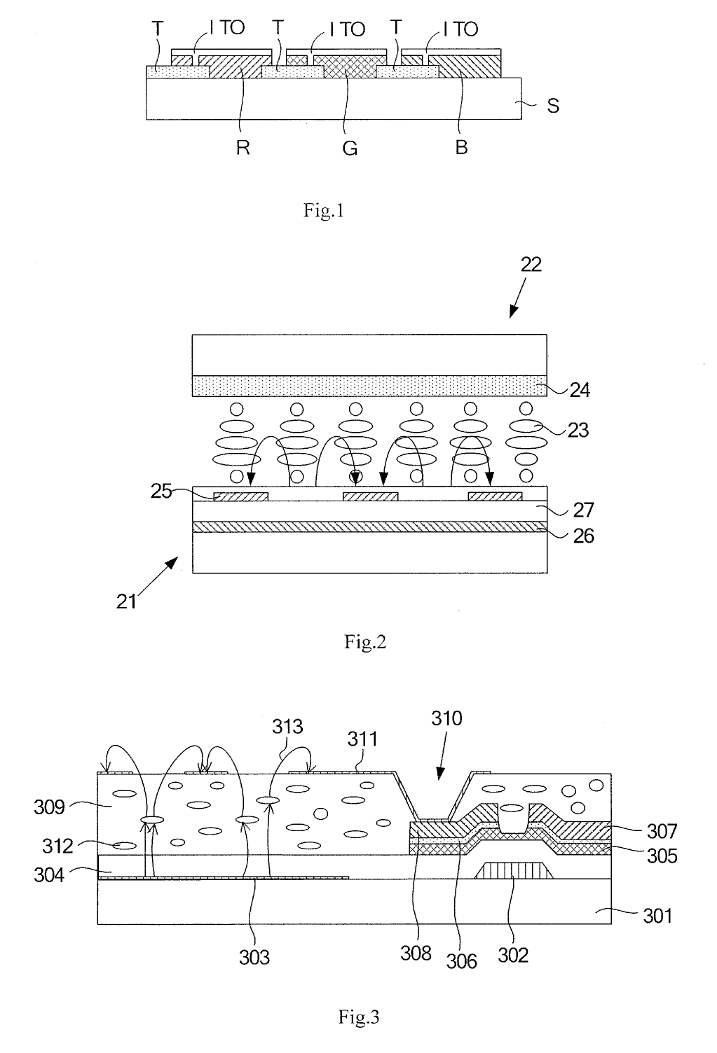

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

An embodiment of the present invention provides an array substrate, which comprises: a pixel electrode and a common electrode; and a color resin layer between the pixel electrode and the common electrode, wherein conductive particles are dispersed within the color resin layer.

An embodiment of the present invention further provides a display substrate, which comprises the aforesaid array substrate.

In the array substrate and the display device comprising the array substrate provided by the embodiments of the present invention, since the conductive particles are added into the color resin layer, the equivalent dielectric thickness of the color resin layer is effectively reduced such that the COA technology can be applied to the FFS type liquid crystal display panel without lowering the aperture ratio of the FFS type liquid crystal display panel, and the integrated level and the production efficiency of the FFS type liquid crystal display panel are improved, whereby the display device comprising the array substrate is provided with a higher integrated level and higher production efficiency.

The array substrate of an embodiment of the present invention will be described below in detail with reference to FIG. 3.

The embodiment of the present invention provide an array substrate, as shown in FIG. 3, the array substrate having an FFS type pixel structure and comprising: a substrate 301; a thin film transistor formed on the substrate 301; a gate electrode 302 and a common electrode 303 that are formed on the substrate 301 and electrically insulated from each other; and a gate insulating layer 304 covering the gate electrode 302 and the common electrode 303.

In the embodiment of the present invention, the array substrate further comprises: a patterned semiconductor layer 305 and a patterned ohmic contact layer 306 that are sequentially formed on the gate insulating layer 304; and a source electrode 307 and a drain electrode 308 that are formed on the patterned ohmic contact layer 306, wherein the gate electrode 302, the gate insulating layer 304, the patterned semiconductor layer 305, the patterned ohmic contact layer 306, the source electrode 307, and the drain electrode 308 together form the aforesaid thin film transistor.

In the embodiment of the present invention, the array substrate further comprises: a color resin layer 309 that covers a surface of the substrate 301 on which the aforesaid thin film transistor (not shown) and the common electrode 303 are formed; a pixel electrode via hole 310 formed in the color resin layer 309 and exposing the drain electrode 308; a pixel electrode 311 formed on a surface of the color resin layer 309 and in the pixel electrode via hole 310, such that the color resin layer 309 is located between the pixel electrode 311 and the common electrode 303.

In the embodiment of the present invention, conductive particles 312 are dispersed within the color resin layer 309.

During the operating process of the array substrate of the embodiment of the present invention, an electric field is formed between the pixel electrode 311 and the common electrode 303. Power lines 313 pass the conductive particles 312 in conduction. Since the interior of the conductor is an equipotential body, it can be deemed that the power lines bypass the conductive particles 312 for further spreading while the size and direction of the power lines do not change, whereby the equivalent dielectric thickness of the color resin layer 309 in which the conductive particles 312 are dispersed is an overall average thickness of a color resin layer which has an equivalent area and from which the conductive particles 312 are removed.

Moreover, when a voltage is applied between the pixel electrode and the common electrode, the strength of the electric field formed in the color resin layer not containing conductive particles is less than the strength of the electric field formed in the color resin layer containing conductive particles in the case that the color resin layers have equal thickness to each other. Therefore, the COA technology can be applied to the FFS type liquid crystal display panel without lowering the aperture ratio of the FFS type liquid crystal display panel, and the integrated level and the production efficiency of the FFS type liquid crystal display panel are improved.

In the embodiment of the present invention, when manufacturing the aforesaid array substrate, the conductive particles need to be dispersed and mixed within the color resin prior to the step of coating the color resin layer, or the conductive particles are dispersed and added at the same time when adding pigment to the resin, while the rest steps may be same as those steps in the prior art. The latter method of dispersing the conductive particles will not add any processing step of liquid crystal display panel, so the production efficiency will be improved and the manufacturing costs reduced.

In embodiments of the present invention, the size and amount of the conductive particles can be suitably selected by those skilled in the art according to the process requirements. It has been found through experiments that the array substrate provided with a color resin layer, where the conductive particles account for 3% to 8% of the mass of the color resin layer, can ensure better performance during operation.

In the embodiments of the present invention, in order to ensure uniform distribution of the electric field formed between the pixel electrode and the common electrode throughout the entire color resin layer, the conductive particles may be uniformly dispersed within the color resin layer. But, the embodiments of the present invention are not limited to this.

The conductive particles may be any one kind among metal particles, conductive metal oxide particles, metal particles coated pigment, conductive metal oxide particles coated pigment, or any combination of two or more of the above particles. It is understood by those skilled in the art that the types of conductive particles are not limited to the above, and any other particles that have conductive characteristic and can reduce the equivalent dielectric thickness of the color resin layer can be applied to the present invention.

In the embodiments of the present invention, the conductive metal oxide particles may be transparent conductive particles. Apparently, the color resin layer in which transparent conductive particles are dispersed has a transmittance higher than that of the color resin layer in which opaque conductive particles are dispersed.

In addition, the materials for the conductive metal oxide particles may be any one of indium tin oxide (ITO), indium zinc oxide (IZO), aluminum zinc oxide (AZO), indium gallium zinc oxide (IGZO), or any combination of two or more of the above oxides.

When manufacturing the metal particles coated pigment or the conductive metal oxide particles coated pigment, such methods as gas-phase evaporation deposition, chemical deposition, spray coating and etc. can be adopted.

In the above array substrates provided in the embodiments of the present invention, the pixel electrode and the common electrode may be relatively located as shown in FIG. 3, i.e., the pixel electrode 311 may be provided over the common electrode 303, or the common electrode may be provided over the pixel electrode. When the common electrode is provided over the pixel electrode, the thin film transistor is adjusted accordingly into such a configuration as to facilitate the electrical connection between the pixel electrode and the common electrode.

In the above array substrates provided in the embodiments of the present invention, both the pixel electrode and the common electrode may be in slit-like electrode structures, or as shown in FIG. 3, the pixel electrode 311 is in a slit-like electrode structure and the common electrode 303 is a plate-like electrode when the pixel electrode 311 is disposed over the common electrode 303, or the common electrode is in a slit-like electrode structure and the pixel electrode is a plate-like electrode when the common electrode is disposed over the pixel electrode.

In the embodiments of the present invention, since the conductive particles are added to the color resin layer, the equivalent dielectric thickness of the color resin layer is effectively reduced such that the COA technology can be applied to the FFS type liquid crystal display panel without lowering the aperture ratio of the FFS type liquid crystal display panel, and the integrated level and the production efficiency of the FFS type liquid crystal display panel are improved.

An embodiment of the present invention further provides a display device comprising the aforesaid array substrate. The display device may be a liquid crystal panel, a liquid crystal display, a liquid crystal television and etc. By using the aforesaid array substrate, the display device can have a higher integrated level and production efficiency.

The above embodiments are used for illustrating the technical solutions of the present invention only and not limitative to the scope of the disclosure. While the present invention has been detailedly described with reference to the foregoing embodiments, it shall be understood by those skilled in the art that any amendment to the technical solutions or substitution for some of the technical features shall also be allowed without departing from the scope and spirit of the present invention.

1. An array substrate, comprising a pixel electrode and a common electrode, and a color resin layer between the pixel electrode and the common electrode, wherein conductive particles are dispersed within the color resin layer.

2. The array substrate according to claim 1, wherein the conductive particles are uniformly dispersed within the color resin layer.

3. The array substrate according to claim 1, wherein the conductive particles account for 3% to 8% of the mass of the color resin layer.

4. The array substrate according claim 1, wherein the conductive particles are any one kind of metal particles, conductive metal oxide particles, metal particles coated pigment, conductive metal oxide particles coated pigment, or any combination of two or more of the above particles.

5. The array substrate according to claim 1, wherein the conductive particles are transparent conductive particles.

6. The array substrate according to claim 4, wherein a material for the conductive metal oxide particles is any one of indium tin oxide, indium zinc oxide, aluminum zinc oxide, indium gallium zinc oxide, or any combination of two or more of the above oxides.

7. The array substrate according to claim 1, wherein the pixel electrode and the common electrode are in a position relationship in which the pixel electrode is disposed over the common electrode, or the common electrode is disposed over the pixel electrode.

8. The array substrate according to claim 1, wherein both the pixel electrode and the common electrode are in slit-like electrode structures.

9. The array substrate according to claim 1, wherein the pixel electrode is disposed over the common electrode, the pixel electrode is in a slit-like electrode structure and the common electrode is a plate-like electrode; or the common electrode is disposed over the pixel electrode, the common electrode is in a slit-like electrode structure and the pixel electrode is a plate-like electrode.

10. A display device, comprising an array substrate according to claim 1.

11. The array substrate according to claim 2, wherein the conductive particles account for 3% to 8% of the mass of the color resin layer.

12. The array substrate according to claim 2, wherein the conductive particles are any one kind of metal particles, conductive metal oxide particles, metal particles coated pigment, conductive metal oxide particles coated pigment, or any combination of two or more of the above particles.

13. The array substrate according to claim 2, wherein the conductive particles are transparent conductive particles.

14. The array substrate according to claim 12, wherein a material for the conductive metal oxide particles is any one of indium tin oxide, indium zinc oxide, aluminum zinc oxide, indium gallium zinc oxide, or any combination of two or more of the above oxides.

15. The array substrate according to claim 2, wherein the pixel electrode and the common electrode are in a position relationship in which the pixel electrode is disposed over the common electrode, or the common electrode is disposed over the pixel electrode.

16. The array substrate according to claim 2, wherein both the pixel electrode and the common electrode are in slit-like electrode structures.

17. The array substrate according to claim 2, wherein the pixel electrode is disposed over the common electrode, the pixel electrode is in a slit-like electrode structure and the common electrode is a plate-like electrode; or the common electrode is disposed over the pixel electrode, the common electrode is in a slit-like electrode structure and the pixel electrode is a plate-like electrode.
